(19) United States
(12) Patent Application Publication
(10) Pub. No.: US 2025/0293562 A1
(43) Pub. Date: Sep. 18, 2025

(54) COOLING SYSTEM FOR ELECTRIC MACHINE

(71) Applicant: General Electric Company, Schenectady, NY (US)

(72) Inventor: Eyitayo James Owoeye, Houston, TX (US)

(21) Appl. No.: 18/602,093

(22) Filed: Mar. 12, 2024

(51) Int. Cl. H02K 3/24; H02K 1/20; H02K 1/32

(52) U.S. Cl. CPC H02K 3/24; H02K 1/20; H02K 1/32

(57) ABSTRACT

A cooling apparatus for an electric machine includes a body, a plurality of channels defined in the body, and a manifold. The body extends from a first end to a second end and defines an outer surface, an inner surface, and a cavity interior of the inner surface. The cavity is configured to receive electric machine windings of the electric machine. The plurality of channels extend from the first end to the second end. Each of the plurality of channels is disposed between the inner surface and the outer surface. The manifold defines a fluid port and is arranged to engage the body at one of the first end or the second end to form a fluidtight chamber enclosing the plurality of channels from the cavity. The fluidtight chamber is in fluid communication with the fluid port.

### FIELD

The present disclosure relates to gas turbine engines, and more specifically, to an apparatus for cooling electric machines in gas turbine engines.

### BACKGROUND

Typical aircraft propulsion systems include one or more gas turbine engines. For certain propulsion systems, the gas turbine engines generally include a fan and a core arranged in flow communication with one another. Additionally, the core of the gas turbine engine generally includes, in serial flow order, a compressor section, a combustion section, a turbine section, and an exhaust section.

Incorporating an electrical machine (e.g., an electrical generator) into a propulsion engine to generate electrical power from mechanical energy generated by the propulsion engine may enhance the capabilities of aircraft. For example, the electrical power generated by the electrical machine may be used to operate an accessory propulsor (e.g., an electric fan, motor, or the like) to supplement thrust provided via the turbine engine. When generating the electrical power, heat is generated from electrical resistance of the currents of the electrical power. This generated heat further increases the electrical resistance of components of the electrical machine, thereby reducing the amount of electrical power generated by the electrical machine. Dissipating this generated heat can improve electrical power generation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine according to one example embodiment of the present disclosure.

FIG. 2 is a front schematic view of an electric machine of the gas turbine engine.

FIG. 3 is a perspective view of a cooling apparatus of the electric machine.

FIG. 4 is a perspective view of a body of a cooling apparatus.

FIG. 5A is a cross-sectional view of an exemplary arrangement of the body of the cooling apparatus along the line 5-5.

FIG. 5B is a cross-sectional view of another exemplary arrangement of the body of the cooling apparatus along the line 5-5.

FIG. 5C is a cross-sectional view of another exemplary arrangement of the body of the cooling apparatus along the line 5-5.

FIG. 6A is a perspective view of an exemplary cooling apparatus.

FIG. 6B is a perspective view of another exemplary cooling apparatus.

FIG. 6C is a perspective view of another exemplary cooling apparatus.

FIG. 7 is a perspective view of another exemplary cooling apparatus.

FIG. 8A is a cross-sectional view of the cooling apparatus along the line 8-8.

FIG. 8B is a cross-sectional view of another cooling apparatus.

FIG. 8C is a cross-sectional view of another cooling apparatus.

FIG. 9A is a perspective view of an exemplary unit cell of the cooling apparatuses shown in FIGS. 8B-8C.

FIG. 9B is a perspective view of another exemplary unit cell of the cooling apparatuses shown in FIGS. 8B-8C.

FIG. 9C is a perspective view of another exemplary unit cell of the cooling apparatuses shown in FIGS. 8B-8C.

FIG. 9D is a perspective view of another exemplary unit cell of the cooling apparatuses shown in FIGS. 8B-8C.

FIG. 9E is a perspective view of another exemplary unit cell of the cooling apparatuses shown in FIGS. 8B-8C.

FIG. 9F is a perspective view of another exemplary unit cell of the cooling apparatuses shown in FIGS. 8B-8C.

FIG. 9G is a perspective view of another exemplary unit cell of the cooling apparatuses shown in FIGS. 8B-8C.

FIG. 9H is a perspective view of another exemplary unit cell of the cooling apparatuses shown in FIGS. 8B-8C.

FIG. 10A is a perspective view of another exemplary cooling apparatus.

FIG. 10B is a perspective view of another exemplary cooling apparatus.

FIG. 10C is a perspective view of another exemplary cooling apparatus.

FIG. 11 is an axial schematic view of an electric machine.

FIG. 12 is a side cross-sectional view of the electric machine.

FIGS. 13A is a side cross-sectional view of another exemplary electric machine.

FIG. 13B is a side cross-sectional view of another exemplary electric machine.

FIG. 13C is a side cross-sectional view of another exemplary electric machine.

FIG. 14 is an axial schematic view of another electric machine.

FIG. 15 is a side cross-sectional view of the electric machine.

FIG. 16A is a side cross-sectional view of another exemplary electric machine.

FIG. 16B is a side cross-sectional view of another exemplary electric machine.

FIG. 16C is a side cross-sectional view of another exemplary electric machine.

FIG. 17 is an axial schematic view of another electric machine.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The terms “upstream” and “downstream” refer to the relative direction with respect to fluid flow in a fluid pathway. For example, “upstream” refers to the direction from which fluid flows, and “downstream” refers to the direction to which the fluid flows.

As used herein, the terms “first,” “second,” “third,” and other ordinals are used to distinguish one component from another and are not intended to signify location or importance of the individual components.

The present disclosure is generally related to cooling electric machines in gas turbine engines. During operation, electric machines (such as electric motors and electric generators) generate heat. The heat may interfere with operation of the electric machine, such as increasing an electrical resistance of wires that leads to a decreased magnetic field generated by the wires. Thermal management to dissipate generated heat leads to improved efficiency and lifespan of the electric machines.

Liquid coolants provide heat transfer by convection. Providing a liquid coolant in a solid channel (such as a pipe, tube, or sleeve) that contact the wires in the stator dissipates heat from the wires directly. The wires dissipate heat to solid surfaces of the channel, and the liquid coolant flows along the channel to extract heat from the solid surfaces. Because the liquid coolant does not directly contact the wires, leakage of the coolant is mitigated while providing the beneficial heat transfer properties of convective cooling. With such an apparatus to cool the stator and the rotor, operation of the electric machine is improved. More specifically, the apparatus improves temperature uniformity in the wires, the stator, and the rotor, particularly during high-speed operation, thereby increasing the power density of the electric machine.

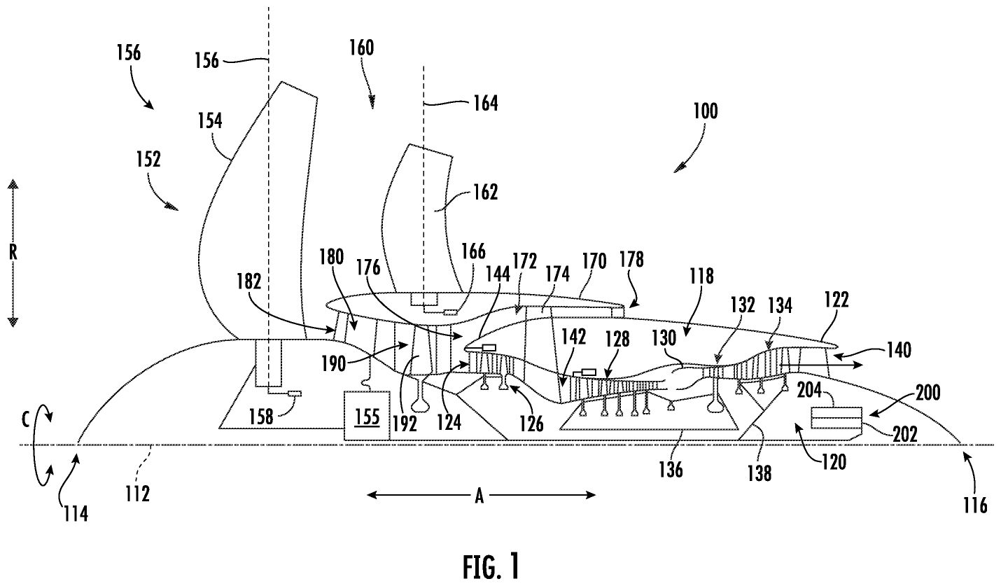

Referring now to FIG. 1, a schematic cross-sectional view of a gas turbine engine according to one example embodiment of the present disclosure is shown. Particularly, FIG. 1 provides an aviation three-stream turbofan engine herein referred to as “three-stream engine 100”. The three-stream engine 100 of FIG. 1 can be mounted to an aerial vehicle, such as a fixed-wing aircraft, and can produce thrust for propulsion of the aerial vehicle. The three-stream engine 100 is a “three-stream engine” in that its architecture provides three distinct streams of thrust-producing airflow during operation.

For reference, the three-stream engine 100 defines an axial direction A, a radial direction R, and a circumferential direction C. Moreover, the three-stream engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The three-stream engine 100 extends between a forward end 114 and an aft end 116, e.g., along the axial direction A.

The three-stream engine 100 includes a turbomachine 120 and a fan section 150 positioned upstream thereof. Generally, the turbomachine 120 includes, in serial flow order, a compressor section, a combustion section, a turbine section, and an exhaust section. Particularly, as shown in FIG. 1, the turbomachine 120 includes an engine core and a core cowl 122 that annularly surrounds the engine core. The engine core and core cowl 122 define an annular core inlet 124. The core cowl 122 further encloses and supports a booster or low pressure (LP) compressor 126 for pressurizing the air that enters the turbomachine 120 through core inlet 124. A high pressure (HP), multi-stage, axial-flow compressor (referred to herein as an HP compressor 128) receives pressurized air from the LP compressor 126 and further increases the pressure of the air. The pressurized air stream flows downstream to a combustor 130 where fuel is injected into the pressurized air stream and ignited to raise the temperature and energy level of the pressurized air.

The high energy combustion products flow from the combustor 130 downstream to a high pressure turbine 132. The high pressure turbine 132 drives the HP compressor 128 through a first shaft or HP shaft 136. In this regard, the high pressure turbine 132 is drivingly coupled with the HP compressor 128. The high energy combustion products then flow to an LP turbine 134. The low pressure turbine 134 drives the LP compressor 126, components of the fan section 150, and an electric machine 200 through a second shaft or LP shaft 138. Specifically, the high energy combustion products drive turbine blades 135 of the low pressure turbine 134. In this regard, the low pressure turbine 134 is drivingly coupled with the LP compressor 126, components of the fan section 150, and the electric machine 200. The LP shaft 138 is coaxial with the HP shaft 136 in this example embodiment. After driving each of the turbines 132, 134, the combustion products exit the turbomachine 120 through a core exhaust nozzle 140 to produce propulsive thrust. Accordingly, the turbomachine 120 defines a core flowpath or core duct 142 that extends between the core inlet 124 and the core exhaust nozzle 140. The core duct 142 is an annular duct positioned generally inward of the core cowl 122 along the radial direction R.

The fan section 150 includes a primary fan 152. For the depicted embodiment of FIG. 1, the primary fan 152 is an open rotor or unducted primary fan 152. However, in other embodiments, the primary fan 152 may be ducted, e.g., by a fan casing or nacelle circumferentially surrounding the primary fan 152. As depicted, the primary fan 152 includes an array of fan blades 154 (only one shown in FIG. 1). The fan blades 154 are rotatable, e.g., about the longitudinal axis 112. As noted above, the primary fan 152 is drivingly coupled with the low pressure turbine 134 via the LP shaft 138. The primary fan 152 can be directly coupled with the LP shaft 138, e.g., in a direct-drive configuration. Optionally, as shown in FIG. 1, the primary fan 152 can be coupled with the LP shaft 138 via a speed reduction gearbox 155, e.g., in an indirect-drive or geared-drive configuration.

Moreover, the fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the primary fan 152 is rotatable about their respective central blades axes 156, e.g., in unison with one another. One or more actuators 158 can be controlled to pitch the fan blades 154 about their respective central blades axes 156. However, in other embodiments, each fan blade 154 may be fixed or unable to be pitched about its central blade axis 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in

FIG. 1 or may be shrouded, e.g., by an annular shroud spaced outward from the tips of the fan guide vanes 162 along the radial direction R. Each fan guide vane 162 defines a central blade axis 164. For this embodiment, each fan guide vane 162 of the fan guide vane array 160 is rotatable about their respective central blades axes 164, e.g., in unison with one another. One or more actuators 166 can be controlled to pitch the fan guide vane 162 about their respective central blades axes 164. However, in other embodiments, each fan guide vane 162 may be fixed or unable to be pitched about its central blade axis 164. The fan guide vanes 162 are mounted to a fan cowl 170.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flowpath or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced struts 174 (only one shown in FIG. 1). The struts 174 may each be aerodynamically contoured to direct air flowing thereby. Other struts in addition to struts 174 may be used to connect and support the fan cowl 170 and/or core cowl 122.

The three-stream engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the primary fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a nose of a splitter 144 of the core cowl 122. The inlet duct 180 is wider than the core duct 142 along the radial direction R. The inlet duct 180 is also wider than the fan duct 172 along the radial direction R.

As depicted, the fan section 150 also includes a mid-fan 190. The mid-fan 190 includes an array of mid-fan blades 192 (only one shown in FIG. 1). Each mid-fan blade 192 has a root and a tip and a span defined therebetween. The mid-fan blades 192 are rotatable, e.g., about the longitudinal axis 112. The mid-fan 190 is drivingly coupled with the low pressure turbine 134 via the LP shaft 138. The mid-fan blades 192 can be arranged in equal circumferential spacing around the longitudinal axis 112. The mid-fan blades 192 are annularly surrounded or ducted by the fan cowl 170. In this regard, the mid-fan 190 is positioned inward of the fan cowl 170 along the radial direction R. Moreover, for this example embodiment, the mid-fan 190 is positioned within the inlet duct 180 upstream of both the core duct 142 and the fan duct 172.

Accordingly, air flowing through the inlet duct 180 flows across the mid-fan blades 192 and is accelerated downstream thereof, particularly at the tips of the mid-fan blades 192. At least a portion of the air accelerated by the mid-fan blades 192 flows into the fan duct 172 and is ultimately exhausted through the fan exhaust nozzle 178 to produce propulsive thrust. Also, at least a portion of the air accelerated by the mid-fan blades 192 flows into the core duct 142 and is ultimately exhausted through the core exhaust nozzle 140 to produce propulsive thrust. Generally, the mid-fan 190 is a compression device positioned downstream of the engine inlet 182. The mid-fan 190 is operable to accelerate air into the fan duct 172 or secondary bypass passage.

It will be appreciated, however, that the exemplary three-stream engine 100 is provided by way of example only. In other exemplary embodiments, the three-stream engine 100 may have any other configuration. For example, in other exemplary embodiments, the turbomachine 120 may have any other number and arrangement of shafts, spools, compressors, turbines, etc. Further, in other exemplary embodiments, the three-stream engine 100 may alternatively be configured as a ducted turbofan engine (including an outer nacelle surrounding the primary fan 152 and a portion of the turbomachine 120); as a direct drive gas turbine engine (may not include a reduction gearbox, such as the speed reduction gearbox 155); as a fixed pitch gas turbine engine (may not include a variable pitch fan, such as the primary fan 152); as a two-stream gas turbine engine (may not include the fan duct 172); etc.

Further, for the depicted embodiment of FIG. 1, the three-stream engine 100 includes an electric machine 200 operably coupled with a rotating component thereof. In this regard, the three-stream engine 100 is an aeronautical hybrid-electric propulsion machine. Particularly, as shown in FIG. 1, the three-stream engine 100 includes the electric machine 200 operatively coupled with the LP shaft 138. The electric machine 200 includes a stator assembly 202 and a rotor assembly 204 rotatable within the stator assembly 202. The electric machine 200 can be directly mechanically connected to the LP shaft 138, as is shown, or alternatively the electric machine 200 can be mechanically coupled with the LP shaft 138 indirectly, e.g., by way of a gearbox. Further, although the electric machine 200 is operatively coupled with the LP shaft 138 at an aft end of the LP shaft 138, the electric machine 200 can be coupled with the LP shaft 138 at any suitable location or can be coupled to other rotating components of the three-stream engine 100, such as the HP shaft 136.

In some embodiments, the electric machine 200 can be an electric motor operable to drive or motor the LP shaft 138, e.g., during an engine burst. In other embodiments, the electric machine 200 can be an electric generator operable to convert mechanical energy into electrical energy. In this way, electrical power generated by the electric machine 200 can be directed to various engine and/or aircraft systems. In some embodiments, the electric machine 200 can be a motor/generator with dual functionality.

It will be appreciated that, in addition to the three-stream engine 100 described above, the gas turbine engine may have any other suitable configuration. Such configurations may include ducted, direct drive, fixed pitch, or turboprop, among others.

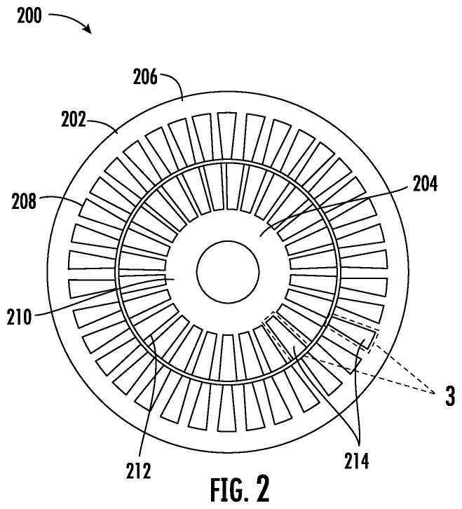

Now referring to FIG. 2, a front schematic view of the electric machine 200 is provided. As stated above, the electric machine 200 includes the stator assembly 202 and the rotor assembly 204. The stator assembly 202 includes a stator core 206 defining a plurality of stator slots 208, and the rotor assembly 204 includes a rotor core 210 defining a plurality of rotor slots 212. The stator slots 208 and the rotor slots 212 house windings (not shown) through which current is provided or induced. As stated above, during operation of the electric machine 200, the windings emit heat, which may increase electrical resistance in the windings and reduce overall output of the electric machine 200. The electric machine 200 includes a plurality of cooling apparatuses 214, each one of the stator slots 208 and the rotor slots 212 including one of the cooling apparatuses 214 to cool the windings therein, the stator core 206, and the rotor core 210. It will be appreciated that, in addition to the cooling apparatuses 214, the electric machine 200 may include other devices that transfer heat away from the stator assembly 202 and the rotor assembly 204, such as a cooling plate (not shown).

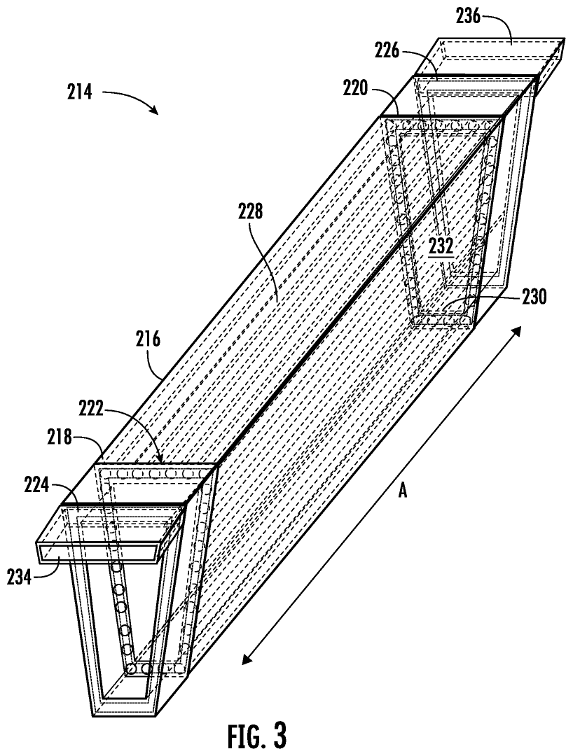

Now referring to FIG. 3, a perspective view of one of the cooling apparatuses 214 of the electric machine 200 is provided, as identified by the label 3 in FIG. 2. The cooling apparatus 214 extends along an axial direction A, which aligns with an axial direction A of the three-stream engine 100 described above.

The cooling apparatus 214 includes a body 216 extending from a first end 218 to a second end 220, a plurality of channels 222 defined in the body 216, an inlet manifold 224 disposed at the first end 218 of the body 216, and an outlet manifold 226 disposed at the second end 220 of the body 216. Coolant flows from a coolant supply (not shown) through the cooling apparatus 214 to cool the windings disposed in the stator slot 208 or the rotor slot 212. More specifically, the coolant flows into the inlet manifold 224, through the channels 222 from the first end 218 to the second end 220, and out from the outlet manifold 226 back to the coolant supply.

The body 216 defines an outer surface 228, an inner surface 230, and a cavity 232 interior of the inner surface 230. The outer surface 228 contacts the stator core 206 or the rotor core 210. The cavity 232 is configured to receive the windings of the electric machine 200, which are enclosed by the inner surface 230.

The channels 222 extend from the first end 218 to the second end 220 and between the inner surface 230 and the outer surface 228. The channels 222 are fluidly connected to the inlet manifold 224 to receive the coolant and to the outlet manifold 226 to transmit the coolant. The channels 222, as described in greater detail below, may be formed in one of a number of configurations, such as by drilling, boring, additive manufacturing, or combinations thereof.

The inlet manifold 224 provides the coolant from the coolant supply to the channels 222. The inlet manifold 224 defines a fluid port 234 through which the coolant supply provides the coolant. The inlet manifold 224 is attached to the body 216 at the first end 218. More specifically, the inlet manifold 224 is shaped to enclose the channels 222 at the first end 218 of the body 216 by forming a fluidtight friction fit with the outer surface 228, inhibiting leaking of the coolant. The inlet manifold 224 defines a cavity that is continuous with the cavity 232 of the body 216 to allow windings therethrough. The inlet manifold 224 may provide secondary cooling to the windings.

The outlet manifold 226 receives the coolant from the channels 222. The outlet manifold 226 defines a fluid port 236 through which the coolant flows from the channels 222 back to the coolant supply. The outlet manifold 226 is attached to the body 216 at the second end 220, forming a fluidtight friction fit with the outer surface 228. The inlet manifold 224 and the outlet manifold 226, when attached to the body 216, form a fluidtight chamber enclosing the plurality of channels 222 from the cavity 232. The fluidtight chamber is in fluid communication with the fluid ports 234, 236 of the inlet manifold 224 and the outlet manifold 226 to provide the coolant to the channels 222, thereby cooling the windings without leaking coolant into the cavity 232. The outlet manifold 226 defines a cavity that is continuous with the cavity 232 of the body 216 to allow windings therethrough. The outlet manifold 226 may provide secondary cooling to the windings.

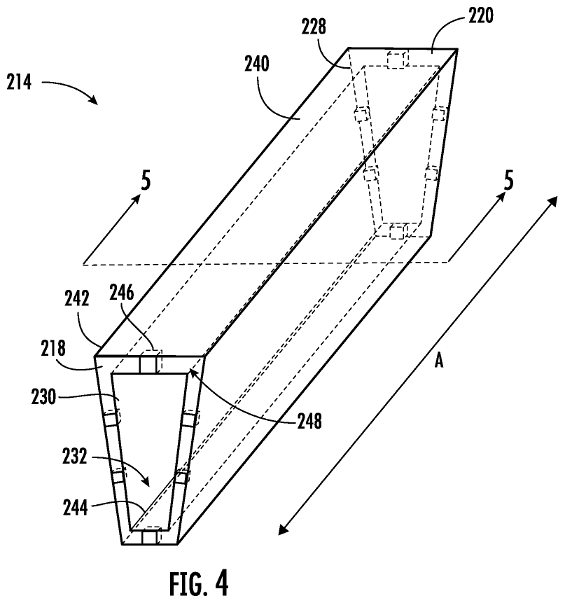

With reference now to FIG. 4, a perspective view of another body 240 of a cooling apparatus 214 is provided. The exemplary body 240 of FIG. 4 may be configured in substantially the same manner as the exemplary body 216 of FIG. 3, and accordingly, the same or similar numbers may refer to the same or similar parts. It will be appreciated that, throughout the figures, same or similar numbers may refer to the same or similar parts.

The body 240 of FIG. 4 includes an outer sleeve 242, an inner sleeve 244 and a plurality of connectors 246 extending between and connecting the outer sleeve 242 to the inner sleeve 244The outer sleeve 242 defines an outer surface 228 of the body 240, and the inner sleeve 242 defines an inner surface 230 of the body. A cavity 232 is defined interior of the inner sleeve 244, and electric machine windings (not shown) are housed in the cavity 232. A plurality of channels 248 are defined between the outer sleeve 242 and the inner sleeve 244 and between the connectors 246 to allow coolant therethrough. By forming the body 240 with the outer sleeve 242 and the inner sleeve 244, the channels 248 are defined by the connectors 246, which may be arranged to provide specified coolant flow through the body 240. The connectors 246 provide structural support, linking the outer sleeve 242 to the inner sleeve 244.

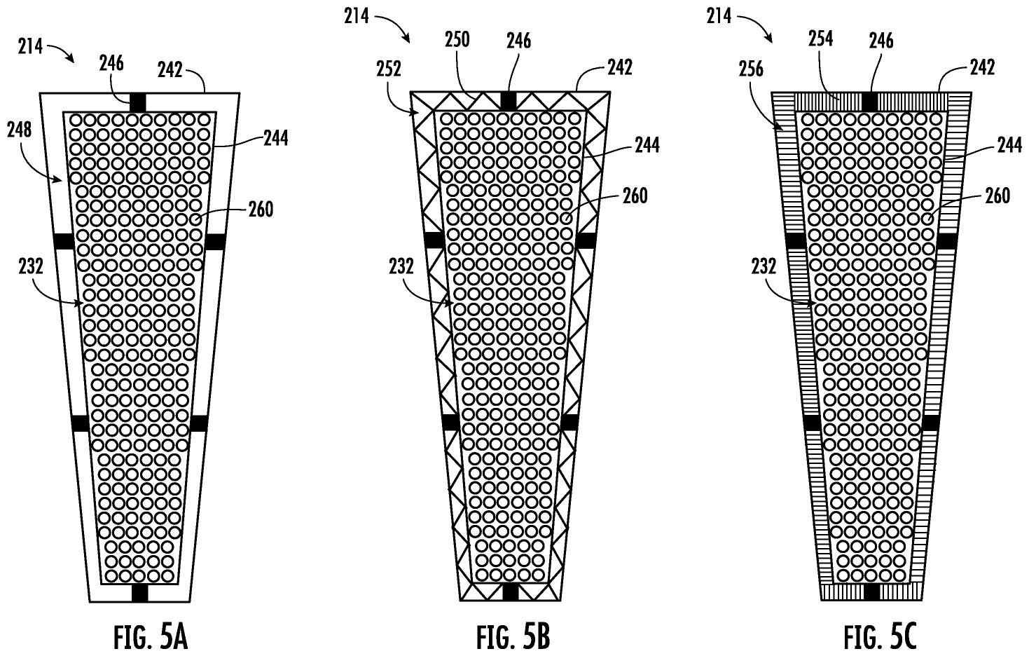

More specifically, referring now to FIGS. 5A-5C, cross-sectional views of exemplary arrangements of the cooling apparatuses 214 are shown. The cross-sectional views are taken along the line 5-5 in FIG. 4. FIG. 5A shows the plurality of connectors 246 that define a single channel 248 for the coolant. FIG. 5B shows a plurality of dividers 250 arranged diagonally between the outer sleeve 242 and the inner sleeve 244 that define triangularly-shaped channels 252 for the coolant. FIG. 5C shows a plurality of dividers 254 shaped as pins or fins arranged in straight lines between the outer sleeve 242 and the inner sleeve 244 that define flow patterns 256 for the coolant. A plurality of windings 260 is disposed in the cavity 232 of each cooling apparatus 214. In this context, “dividers” are structures that are disposed between the outer sleeve 242 and the inner sleeve 244 and that alter flow of the coolant.

As shown in FIGS. 4 and 5A, the connectors 246 are located at a several locations between the outer sleeve 242 and the inner sleeve 244. The connectors 246 secure the outer sleeve 242 to the inner sleeve 244 at a first end 218 of the body 240 and at a second end 220 (FIG. 4) of the body 240. As also shown in FIG. 4, the connectors 246 do not extend from the first end 218 to the second end 220, terminating partway in the body 240. In such a form, the remaining space between the outer sleeve 242 and the inner sleeve 244 forms a single channel 248 that allows the coolant to flow unencumbered from the first end 218 to the second end 220. In the channel 248, the coolant may flow around the inner sleeve 244 to absorb heat from the windings 260.

As shown in FIG. 5B, the dividers 250 extend diagonally between the outer sleeve 242 and the inner sleeve 244 to form triangularly-shaped channels 252. The dividers 250 extend from the first end 218 to the second end 220 (FIG. 4), and the coolant flows through the channels 252 without flowing around the inner sleeve 244. The triangular shape of the channels 252 provides additional surface area for the coolant to contact. The dividers 250 absorb heat from the inner sleeve 244 (transferred from the windings 260), and the coolant flows across the surfaces of the dividers 250 to transfer heat from the dividers 250. By increasing the surface area of the dividers 250, the increased contact with the coolant increases heat transfer from the windings 260.

Additionally or alternatively, the dividers 250 may define other patterns not shown in the figures, such as a curved shape, a U-shape, a spiral pattern, or combinations thereof. It will be appreciated that the specific patterns may be chosen for specific heat transfer characteristics of the cooling apparatus 214.

As shown in FIG. 5C, the dividers 254 extend vertically or horizontally between the outer sleeve 242 and the inner sleeve 244 to form flow patterns 256. The dividers 254 are arranged along the outer sleeve 242 and the inner sleeve 244 from the first end 218 to the second end 220 (FIG. 4) in a lattice or grid-like pattern, and the coolant flows through the flow patterns 256. The dividers 254 provide more surface area and generate more flow turbulence than the dividers 250 of FIG. 5B, further increasing heat transfer from the windings 260.

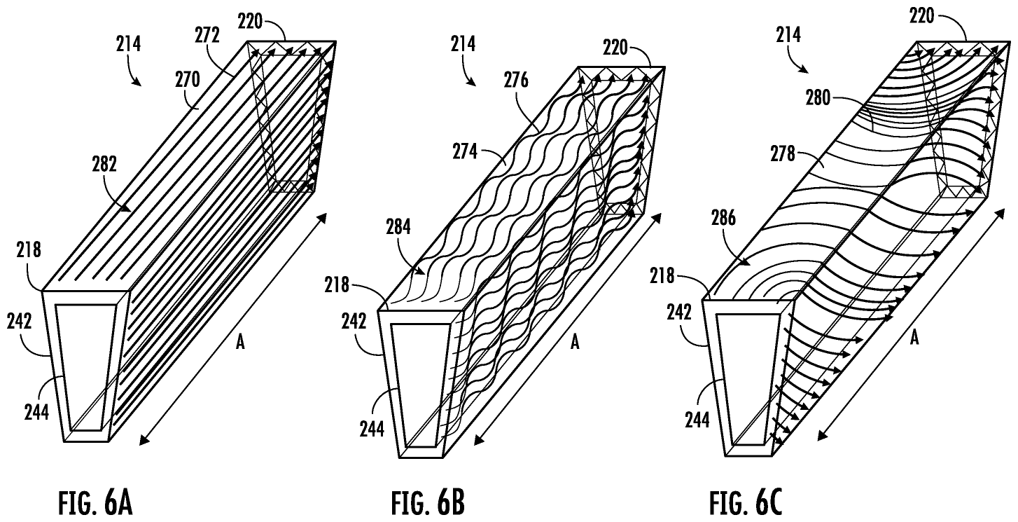

With reference now to FIGS. 6A-6C, perspective views of exemplary bodies of cooling apparatuses are provided. The bodies of the cooling apparatuses of FIGS. 6A-6C may also be configured in a similar manner as the body 240 of FIG. 4.

FIG. 6A shows a body 270 with dividers 272 that extend along a straight line along the axial direction A from the first end 218 to the second end 220. FIG. 6B shows a body 274 with dividers 276 that extend along a serpentine line from the first end 218 to the second end 220. FIG. 6C shows a body 278 with dividers 280 that extend along a helical line from the first end 218 to the second end 220.

As shown in FIG. 6A, the plurality of dividers 272 extend along straight lines along the axial direction A from the first end 218 of the body 270 to the second end 220 of the body 270. The dividers 272 form straight channels 282 for coolant to flow in the axial direction A without flowing around the body 270. The straight channels 282 allow the coolant to flow directly from the first end 218 to the second end 220, improving heat transfer from the windings (FIGS. 5A-5C) by increasing convective heat transfer with increased speed of the coolant flow.

As shown in FIG. 6B, the plurality of dividers 276 extend along serpentine lines from the first end 218 of the body 274 to the second end 220 of the body 274. The dividers 276 form serpentine channels 284 that undulate between the outer sleeve 242 and the inner sleeve 244. The serpentine channels allow the coolant to flow in the radial direction to the inner sleeve 244, receiving heat from the inner sleeve 244. Then, the coolant flows in the radial direction to the outer sleeve 242 to receive heat from the outer sleeve 242. The coolant then flows back and forth between the inner sleeve 244 and the outer sleeve 242 as the coolant flows from the first end 218 to the second end 220. The serpentine motion of the coolant generates localized flow turbulence, increasing the interaction of the coolant with the outer sleeve 242 and the inner sleeve 244, thereby increasing cooling of the electric machine 200.

As shown in FIG. 6C, the plurality of dividers 280 extend along helical lines from the first end 218 of the body 278 to the second end 220 of the body 278. The dividers 280 form helical channels 286 that extend around the body 278. The helical channels 286 are longer than straight channels (such as the channels 282 shown in FIG. 6A), which increases heat transfer from the windings.

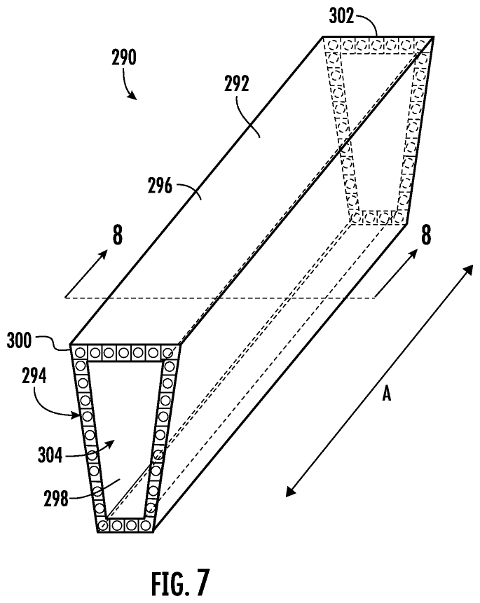

Now referring to FIG. 7, a perspective view of another exemplary cooling apparatus 290 is provided. The exemplary cooling apparatus of FIG. 7 may be configured in a similar manner as one or more of the exemplary cooling apparatuses of FIGS. 4-6C.

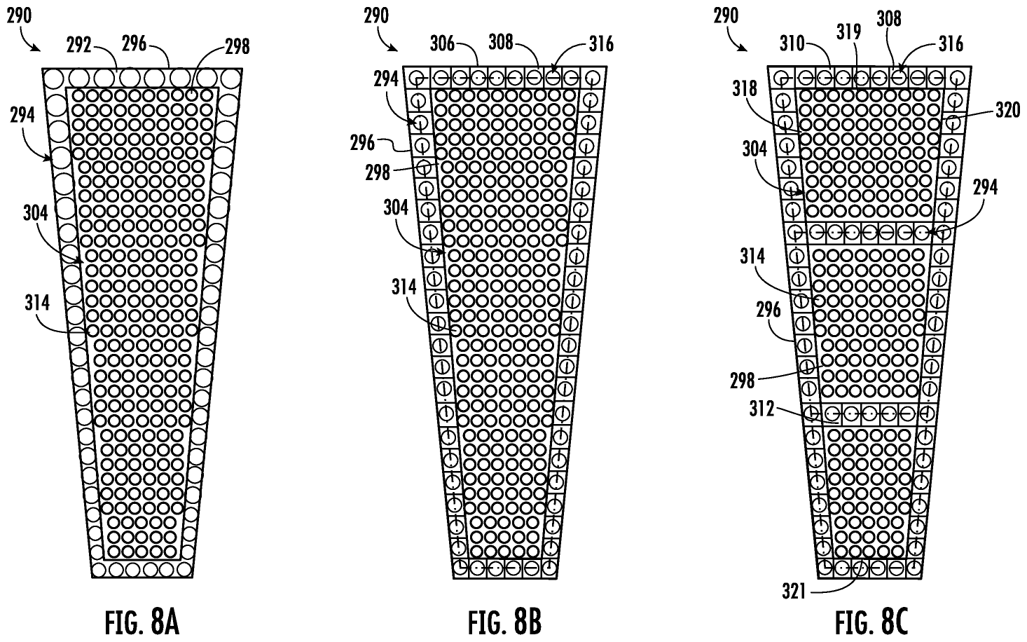

However, for the exemplary embodiment of FIG. 7, rather than including an outer sleeve 242 and an inner sleeve 244 as in the embodiments of FIGS. 4-6C, a body 292 of the cooling apparatus 290 of FIG. 7 is a unitary construction with channels 294 formed between an outer surface 296 and an inner surface 298. Coolant flows through the channels 294 from a first end 300 of the body 292 to a second end 302 of the body 292, transferring heat from windings (FIGS. 8A-8C) disposed in a cavity 304 defined in the body 292. An inlet manifold 224 (FIG. 3) may be attached to the body 292 at the first end 300, and an outlet manifold 226 (FIG. 3) may be attached to the body 292 at the second end 302.

With reference now to FIGS. 8A-8C, cross-sectional views of exemplary aspects of the cooling apparatus 290 along the line 8-8 in FIG. 7 are provided. FIG. 8A is a cross-sectional view of a solid body 292 with channels 294 formed between an outer surface 296 and an inner surface 298. FIG. 8B is a cross-sectional view of a body 306 formed from a plurality of unit cells 308. FIG. 8C is a cross-sectional view of a body 310 with a platform 312 extending through a cavity 304. A plurality of windings 314 are disposed in each cooling apparatus 290.

As shown in FIG. 8A, the body 292 is a solid, monolithic structure in which the channels 294 are formed. The body 292 includes an outer surface 296 and an inner surface 298. The inner surface 298 defines a cavity 304 in which the windings 314 are disposed. The channels 294 are defined between the outer surface 296 and the inner surface 298. The channels 294 extend from the first end 300 of the body 292 to the second end 302 of the body 292. As an example, the body 292 may be extruded as a solid, monolithic piece, and the channels 294 may be bored, drilled, cut, or otherwise removed. Alternatively, the body 292 may be cast in a mold that forms the channels 294 simultaneously with the rest of the body 292. Yet alternative, the body 292 may be additively manufactured, such as by laser metal deposition, laser sintering, laser powder bed fusion, or another suitable process. The channels 294 may have any suitable shape, such as cylindrical, triangular, straight, serpentine, helical, or combinations thereof.

As shown in FIG. 8B, the body 306 includes the plurality of unit cells 308. As will be described in greater detail below, each unit cell 308 includes a microchannel 316 that forms part of one of the channels 294. The unit cells 308 are fused together to form the body 306 into a unitary structure, and the microchannels 316 fluidly connect to each other to form the channels 294. By forming the body 306 from the plurality of unit cells 308, the channels 294 may have more complex geometries than those formed by drilling, boring, or the like, increasing surface area for heat transfer.

As shown in FIG. 8C, an inner surface 298 of the body 310 includes a first side 318 and a second side 320 opposing the first side 318 across a cavity 304 in which the windings 314 are disposed. The platform 312 extends from the first side 318 to the second side 320 through the cavity 304, and the platform 312 defines one or more of the plurality of channels 294. The platform 312 provides coolant to windings 314 closer to a center of the cavity 304, improving heat transfer from windings 314 that are distant from the inner surface 298. As with the body shown in FIG. 8B, the body 310 (including the platform 312) is formed of a plurality of unit cells 308 that include microchannels 316 that form the channels 294 to provide coolant therethrough. The body 310 of FIG. 8C includes two platforms 312, and it will be appreciated that the body 310 may include a different number of platforms, such as one, three, or more.

Additionally or alternatively, the platform 312 may extend from a top side 319 of the body 310 to a bottom side 321 of the body 310, aligning with the first side 318 and the second side 320. Yet additionally or alternatively, the platform 312 may extend between any or all of the first side 318, the top side 319, the second side 320, or the bottom side 321.

The bodies 306, 310 shown in FIGS. 8B-8C includes a single layer of unit cells 308. In another form not shown in the figures, the body may be formed of multiple layers of unit cells 308 to increase the thickness of the body. Some of all of the length of the body may include these multiple layers for specific heat transfer properties and mechanical load constraints.

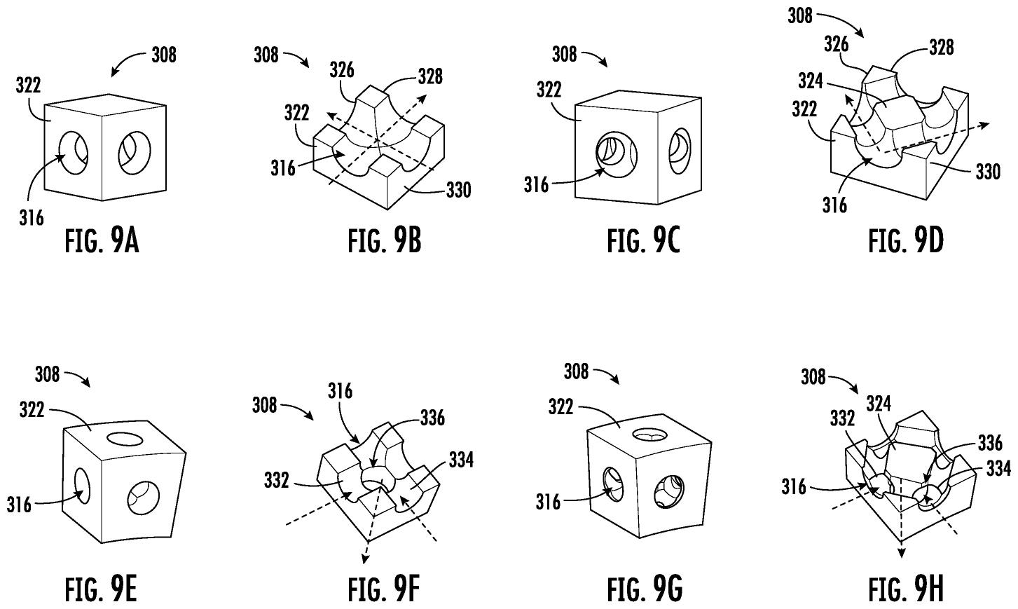

With reference to FIGS. 9A-9H, perspective views are provided of exemplary unit cells 308 of the bodies 306, 310 shown in FIGS. 8B-8C. FIG. 9A is a perspective view of a unit cell 308 with a microchannel 316 open to four of six faces 322 of the unit cell 308. FIG. 9B is a cross-sectional view of the unit cell 308 of FIG. 9A. FIG. 9C is a perspective view of a unit cell 308 with a microchannel 316 open to four of six faces 322 of the unit cell 308. FIG. 9D is a cross-sectional view of the unit cell 308 of FIG. 9C illustrating a central post 324 therein. FIG. 9E is a perspective view of a unit-unit cell 308 with a microchannel 316 open to all six faces 322 of the unit cell 308. FIG. 9F is a cross-sectional view of the unit cell 308 of FIG. 9E. FIG. 9G is a perspective view of a unit cell 308 with a microchannel 316 open to all six faces 322 of the unit cell. FIG. 9H is a cross-sectional view of the unit cell 308 of FIG. 9G illustrating a central post 324 therein.

Referring now to FIGS. 9A-9B, the unit cell 308 has a generally cuboid shape with six rectangular faces 322 that define outer surfaces of the unit cell 308. The unit cell 308 defines the microchannel 316 in four of the six faces 322 of the unit cell 308. The microchannel 316 preferentially allows the coolant to flow from a first surface 326 to an opposing surface 328 and to the adjacent surfaces 330 of the unit cell 308. This coolant flow is also shown with an arrow in FIG. 9B. It will be appreciated that the coolant may flow between any of the surfaces 326, 328, 330, such that any of the surfaces 326, 328, 330 may act as an inlet or an outlet. The merging and splitting of the flow within the unit cell 308 improves heat transfer. The microchannel 316 is in fluid communication with a microchannel 316 of an adjacent unit cell 308, and the microchannels 316 allow the coolant to flow in a two-dimensional grid-like or lattice pattern through the body 306, 310 from a first end 300 to a second end 302.

Referring now to FIGS. 9C-9D, the unit cell 308 includes the central post 324 to increase flow turbulence of the coolant. In such a form, the microchannel 316 preferentially allows the coolant to flow from the first surface 326 to one of the two adjacent surfaces 330 (shown with arrows in FIG. 9D), with less flow to an opposing surface 328. When in fluid communication with a microchannel 316 of an adjacent unit cell 308, the microchannels 316 allow the coolant to flow in a two-dimensional diagonal or diamond-like pattern through the body 306, 310. It will be appreciated that the unit cells 308 of FIGS. 9A-9D may be used when the body 306, 310 has a single layer of unit cells 308 so that the coolant does not leak into the cavity 304.

Referring now to FIGS. 9E-9F, the unit cell 308 defines the microchannel 316 in all six faces 322 of the unit cell 308. In this configuration, the microchannel 316 is a junction that combines two or more incoming flows into a single combined flow or splits a single incoming flow into two or more outgoing flows. More specifically, in the embodiment shown, the junction includes a first inlet 332, a second inlet 334, and an outlet 336. The junction is arranged to combine coolant flowing through the first inlet 332 with coolant flowing through the second inlet 334 to a combined coolant flow through the outlet 336, shown with arrows in FIG. 9F. It will be appreciated that the unit cell 308 may include up to five inlets and up to five outlets, where the total number of inlet and outlets is six to correspond with the six faces 322 of the unit cell 308. As with the unit cell 308 of FIGS. 9A-9B, the microchannels 316 provide coolant flow in a three-dimensional grid-like or lattice pattern through the body 306, 310.

Referring now to FIGS. 9G-9H, the unit cell 308 includes the central post 324 to direct the coolant to adjacent surfaces 330. As with the unit cell 308 of FIGS. 9E-9F, the microchannel is a junction that includes a first inlet 332, a second inlet 334, and an outlet 336. The junction combines coolant flowing through the first inlet 332 with coolant flowing through the second inlet 334 to a combined coolant flow through the outlet 336, shown in arrows in FIG. 9H. It will be appreciated that the unit cell 308 may include up to five inlets and up to five outlets, where the total number of inlet and outlets is six to correspond with the six faces 322 of the unit cell 308. As with the unit cells 308 of FIGS. 9C-9D, the microchannels provide coolant flow in a three-dimensional diagonal or diamond-like pattern through the body. The unit cells 308 of FIGS. 9E-9H may be used when the body 306, 310 has multiple layers of unit cells 308 to allow the coolant to flow three-dimensionally.

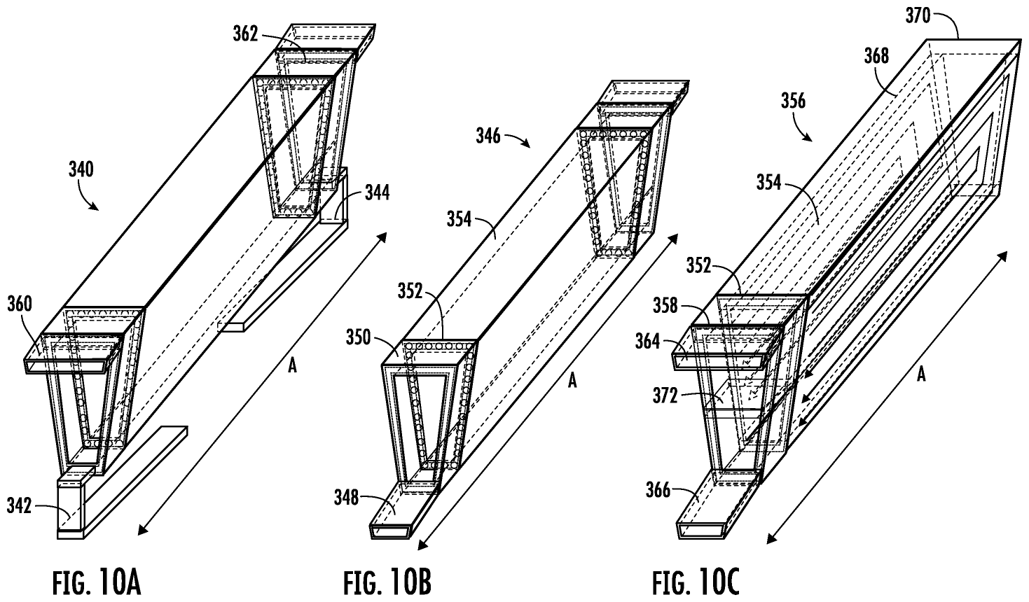

Now referring to FIGS. 10A-10C, perspective views of other exemplary cooling apparatuses are provided. The cooling apparatuses of FIGS. 10A-10C may be configured in a similar manner as one or more of the cooling apparatuses of FIGS. 4-8C.

FIG. 10A is a perspective view of a cooling apparatus 340 with an inlet clip 342 and an outlet clip 344. FIG. 10B is a perspective view of a cooling apparatus 346 with a fluid port 348 of a manifold 350 at an inner portion of a first end 352 a body 354 of the cooling apparatus 346. FIG. 10C is a perspective view of a cooling apparatus 356 including a single manifold 358 attached to the first end 352 of the body 354. For clarity, channels extending through the cooling apparatuses 340, 346 are present but not shown in FIGS. 10A-10B.

As shown in FIG. 10A, the cooling apparatus 340 includes the inlet clip 342 attached to an inlet manifold 360 and the outlet clip 344 attached to an outlet manifold 362. The inlet clip 342 and the outlet clip 344 each engages one of the stator core 206 or the rotor core 210, forming a friction fit that inhibits movement of the cooling apparatus 340. The inlet clip 342 and the outlet clip 344 secure the cooling apparatus 340 in a stator slot 208 or a rotor slot 212.

As shown in FIG. 10B, the manifold 350 includes the fluid port 348 at the inner portion of the first end 352 of the body 354. By positioning the fluid port 348 at the inner portion of the first end 352, the manifold 350 is spaced away from other components, such as the inlet clip 342 shown in FIG. 10A, of other cooling apparatuses 340, 346, 356 disposed in other stator slots 208 or rotor slots 212. This accommodates additional patterns for the windings. The position of the fluid port 348 may reduce the pressure drop of the coolant within the cooling apparatus 346, reducing pumping power needed to flow the coolant.

As shown in FIG. 10C, the manifold 358 at the first end 352 of the body 354 may act as both an inlet and an outlet for the coolant. More specifically, the manifold 358 includes an inlet port 364 that provides the coolant to the body 354 and an outlet port 366 that transmits the coolant from the body 354. Channels 368 defined in the body 354 extend in an axial direction A to a second end 370 and then return in the axial direction A to the first end 352, allowing the coolant to flow forward and aftward in the axial direction A. The manifold 358 may include a partition 372 that separates the coolant entering through the inlet port 364 from the coolant exiting through the outlet port 366. In the example of FIG. 10C, the coolant flows forward and aftward once through the body 354. It will be appreciated that the channels 368 may be defined to allow the coolant to flow more than one time through the body 354, such as three times, five times, seven times, or any suitable number of times.

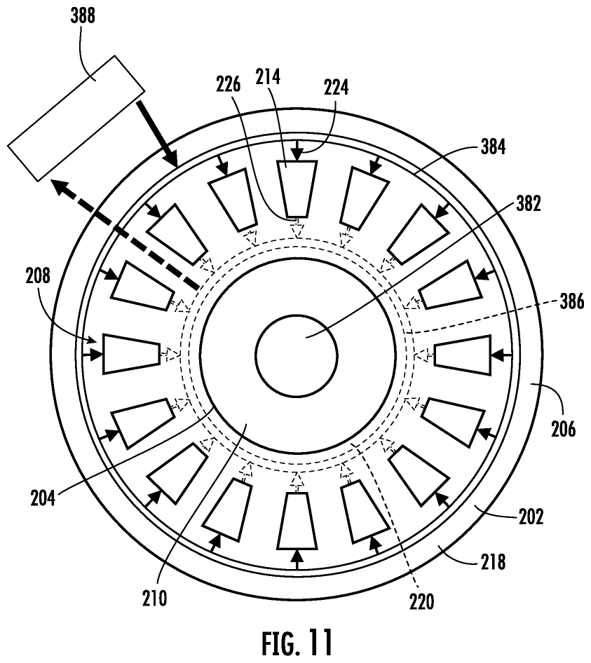

Now referring to FIG. 11, an axial schematic view of an electric machine 380 is provided. As described above, a stator assembly 202 of the electric machine 200 includes a stator core 206 and a plurality of cooling apparatuses 214 disposed in stator slots 208 of the stator core 206. A rotor assembly 204 is disposed radially inward of the stator assembly 202, and the rotor assembly 204 does not include any cooling apparatuses 214 in this exemplary embodiment. The rotor assembly 204 includes a rotor core 210 and a shaft 382. The exemplary electric machine 380 of FIG. 11 may be configured in substantially the same manner as the exemplary electric machine 200 of FIG. 2, and accordingly, as stated above, the same numbers may refer to the same or similar parts.

Each cooling apparatus 214 includes a respective inlet manifold 224, as described above, disposed at a first end 218 of the stator core 206 and a respective outlet manifold 226 disposed at a second end 220 of the stator core 206. The electric machine 200 includes a radial inlet manifold 384 that is fluidly connected to the inlet manifold 224 of each of the cooling apparatuses 214 and a radial outlet manifold 386 that is fluidly connected to the outlet manifold 226 of each of the cooling apparatuses 214. The radial inlet manifold 384 provides coolant from a coolant supply 388 to each of the cooling apparatuses 214, and the radial outlet manifold 386 transfers coolant from each of the cooling apparatuses 214 back to the coolant supply 388. The cooling apparatuses 214 are connected to each other by the radial inlet manifold 384 and the radial outlet manifold 386 in a “parallel flow” configuration, i.e., each cooling apparatus 214 communicates the coolant with the radial inlet manifold 384 and the radial outlet manifold 386, and not with any other cooling apparatuses 214. The parallel flow configuration reduces temperature variation among the plurality of cooling apparatuses 214 and reduces coolant pressure drop.

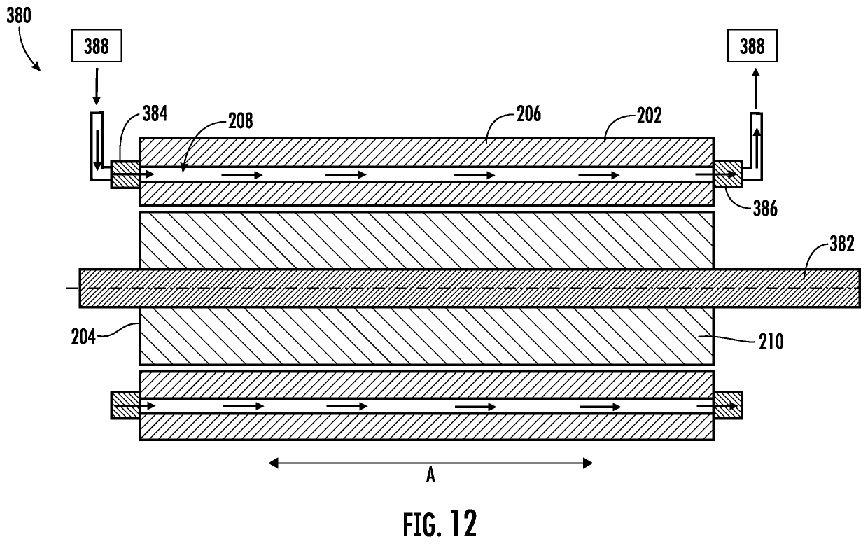

With reference to FIG. 12, a side cross-sectional view of the electric machine 380 is provided. The radial inlet manifold 384 provides the coolant to each of the stator slots through the cooling apparatuses (not shown for clarity). The coolant flows through each of the stator slots 208 to the radial outlet manifold 386. Because the cooling apparatuses 214 (not shown) are connected in the parallel flow configuration, the radial inlet manifold 384 provides the coolant to each of the stator slots 208 substantially simultaneously, and the radial outlet manifold 386 receives the coolant from each of the stator slots 208 substantially simultaneously.

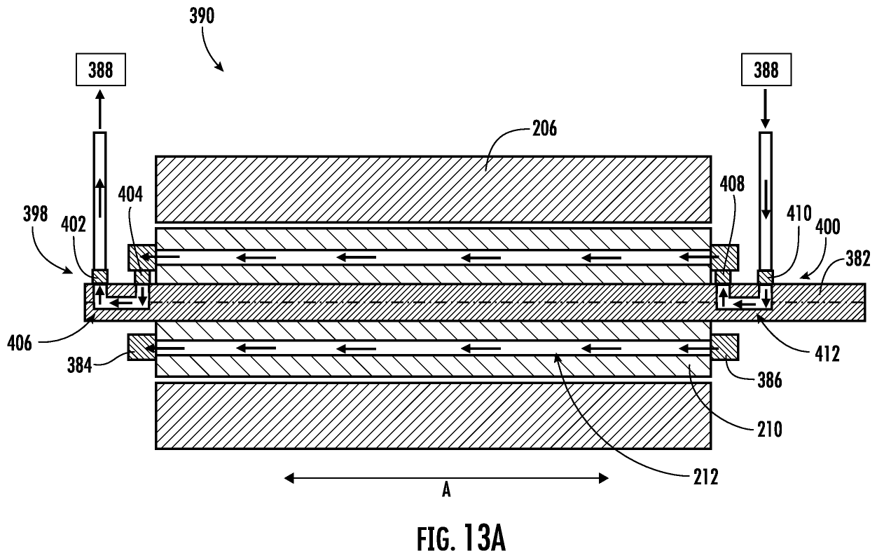

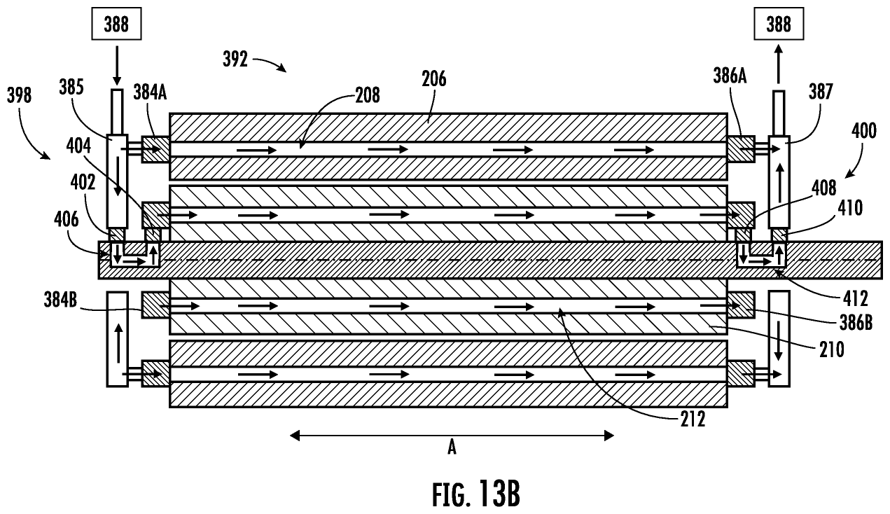

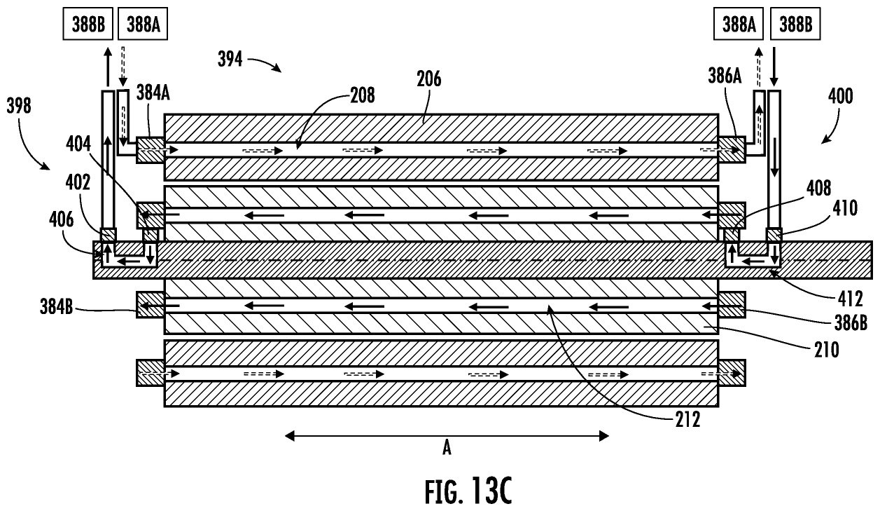

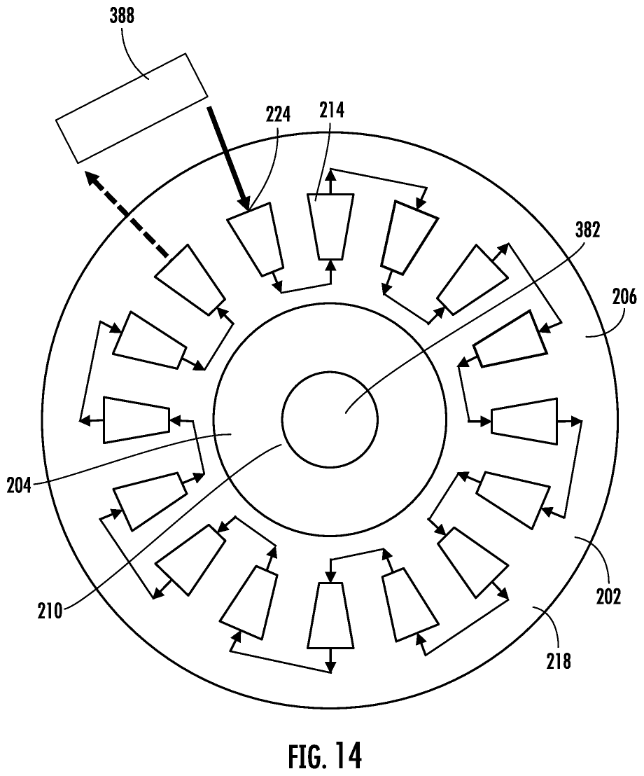

As shown in FIGS. 13A-13C, side cross-sectional views of other exemplary electric machines are provided. FIG. 13A shows an electric machine 390 with a radial inlet manifold 384 and a radial outlet manifold 386 communicating coolant to cooling apparatuses 214 in a rotor assembly 204. FIG. 13B shows an electric machine 392 with a first radial inlet manifold 384A and a first radial outlet manifold 386A communicating coolant between a coolant supply 388 and cooling apparatuses 214 in a stator assembly 202 and a second radial inlet manifold 384B and a second radial outlet manifold 386B communicating coolant between the coolant supply 388 and cooling apparatuses 214 in a rotor assembly 204. FIG. 13C shows an electric machine 394 with a first radial inlet manifold 384A and a first radial outlet manifold 386A communicating coolant between a first coolant supply 388A and cooling apparatuses 214 in a stator assembly 202 and a second radial inlet manifold 384B and a second radial outlet manifold 386B communicating coolant between a second coolant supply 388B and cooling apparatuses 214 in a rotor assembly 204.

With reference to FIG. 13A, the coolant supply 388 provides the coolant to the radial inlet manifold 384 through a first rotary fluid coupling 398 and receives the coolant from the radial outlet manifold 386 through a second rotary fluid coupling 400. The first rotary fluid coupling 398 and the second rotary fluid coupling 400 are connectors disposed in the shaft 382 that fluidly connect the coolant supply 388 to the radial inlet manifold 384 and the radial outlet manifold 386 as the shaft 382 and the rotor core 210 rotate. The first rotary fluid coupling 398 includes an inlet 402, an outlet 404 in fluid communication with the radial inlet manifold 384, and a channel 406 defined in the shaft 382 connecting the inlet 402 to the outlet 404. The second rotary fluid coupling 400 includes an inlet 408 in fluid communication with the radial outlet manifold 386, and outlet 410, and a channel 412 defined in the shaft 382 connecting the inlet 408 to the outlet 410.

Alternatively, not shown in the figures, the inlet 402 and the outlet 404 may be separate rotary fluid couplings that communicate through the channel 406. Likewise, the inlet 408 and the outlet 410 may be separate rotary fluid couplings that communicate through the channel 412.

As the shaft 382 rotates, the inlet 402 of the first rotary fluid coupling 398 and the outlet 410 of the second rotary fluid coupling 400 rotate into engagement with the coolant supply 388. Coolant flows through the inlet 402 of the first rotary fluid coupling 398 through the channel 406 and out from the outlet 404 to the radial inlet manifold 384, and then to the cooling apparatuses 214 in the rotor slots 212. The coolant flows through the rotor slots 212 to the radial outlet manifold 386. The coolant then flows through the inlet 408 of the second rotary fluid coupling 400 through the channel 412 and through the outlet 410 to the coolant supply 388. The shaft 382 continues to rotate until the first rotary fluid coupling 398 and the second rotary fluid coupling 400 rotate out of engagement with the coolant supply 388, ceasing flow of the coolant. In this configuration, the coolant only flows during a portion of the rotation of the rotor assembly 204.

With reference to FIG. 13B, a coolant supply 388 communicates coolant between the first radial inlet manifold 384A, the first radial outlet manifold 386A, the second radial inlet manifold 384B, and the second radial outlet manifold 386B. More specifically, the coolant supply 388 communicates the coolant directly with the first radial inlet manifold 384A and the first radial outlet manifold 386A to provide the coolant to cooling apparatuses 214 in stator slots 208 of the stator assembly 202, as shown in FIG. 12. The coolant supply 388 further communicates the coolant to the second radial inlet manifold 384B and the second radial outlet manifold 386B via a first rotary fluid coupling 398 and a second rotary fluid coupling 400 to provide the coolant to cooling apparatuses 214 in rotor slots 212 of the rotor assembly 204, as shown in FIG. 13B. The coolant supply 388 may provide the coolant through a first central inlet manifold 385 connected to the first radial inlet manifold 384A and the second radial inlet manifold 384B, and the coolant supply 388 may receive the coolant through a second central inlet manifold 387 connected to the first radial outlet manifold 386A and the second radial outlet manifold 386B. The first central inlet manifold 385 and the second central inlet manifold 387 are non-rotating structures that communicate the coolant to and from the coolant supply 388.

With reference to FIG. 13C, the electric machine 394 includes the first coolant supply 388A to provide coolant to the stator assembly 202 and the second coolant supply 388B to provide coolant to the rotor assembly 204. More specifically, the first coolant supply 388A is directly connected to the first radial inlet manifold 384A and the first radial outlet manifold 386A, and the second coolant supply 388B is connected to the second radial inlet manifold 384B with a first rotary fluid coupling 398 and to the second radial outlet manifold 386B with a second rotary fluid coupling 400. By having two separate coolant supplies 388A, 388B, the coolant may flow at different rates, quantities, temperatures, chemical compositions, or combinations thereof, through the stator assembly 202 and the rotor assembly 204. In particular, FIG. 13C shows the coolant flowing through the stator assembly 202 in a direction along an axial direction A, and the coolant flows through the rotor assembly 204 in a direction opposite of the axial direction A. That is, the coolant in the stator assembly 202 flows in an opposing direction to the coolant in the rotor assembly 204 (i.e., a counterflow configuration), which may provide additional heat transfer through the electric machine 394. It will be appreciated that the first and second coolant supplies 388A, 388B may provide coolant through the stator assembly 202 and the rotor assembly 204 is a same direction (i.e., a co-flow configuration).

Now referring to FIG. 14, an axial schematic view of an electric machine 420 is provided. A stator assembly 202 of the electric machine 420 includes a stator core 206 and a plurality of cooling apparatuses 214 disposed in stator slots 208 of the stator core 206. A rotor assembly 204 is disposed radially inward of the stator assembly 202, and the rotor assembly 204 does not include any cooling apparatuses 214 in this exemplary embodiment. The rotor assembly 204 includes a rotor core 210 and a shaft 382.

The cooling apparatuses 214 are arranged in a “serial flow” configuration in which an outlet manifold of a first cooling apparatus 214 is in fluid communication with an inlet manifold of an adjacent cooling apparatus 214. Rather than providing the coolant to all of the cooling apparatuses 214, thereby splitting the flow of the coolant, the coolant supply 388 is only in fluid communication with an inlet manifold 224 of a first one of the cooling apparatuses 214 and an outlet manifold 226 of a last one of the cooling apparatuses 214. In such a configuration, a full flow rate of the coolant is provided to each of the cooling apparatuses 214 sequentially. Each cooling apparatus 214 provides the coolant from its respective outlet manifold 226 to the inlet manifold 224 of the next adjacent cooling apparatus 214, providing the coolant to each cooling apparatus 214 in a serial flowpath from the first one of the cooling apparatuses 214 to the last one of the cooling apparatuses 214. In the example of FIG. 14, it will be appreciated that the inlet manifolds 224 and outlet manifolds 226 are indicated by the direction of the arrows that indicate the flow of the coolant. The serial flow configuration reduces flow variation among the plurality of cooling apparatuses 214.

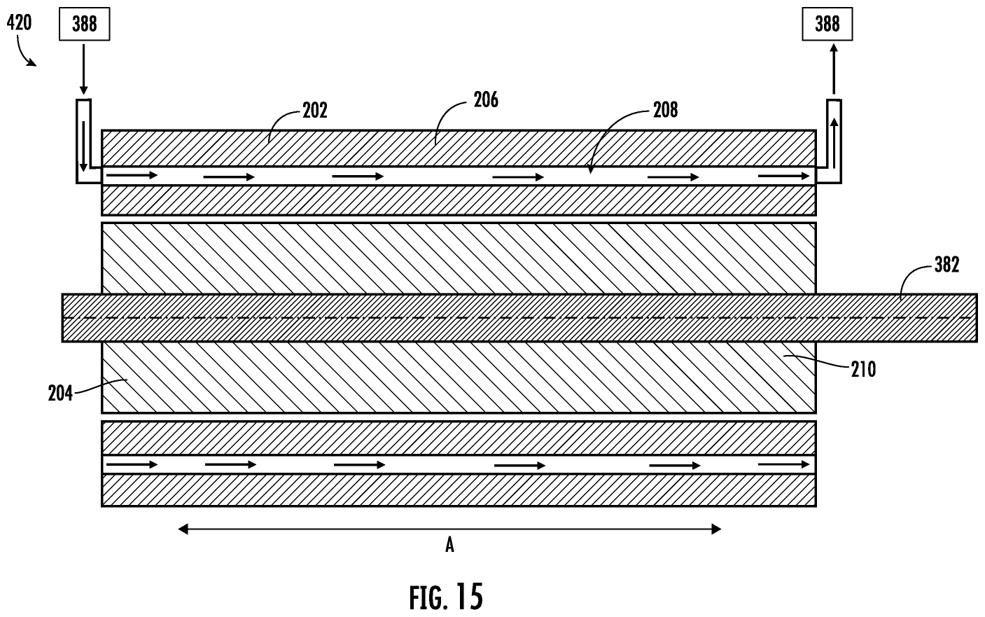

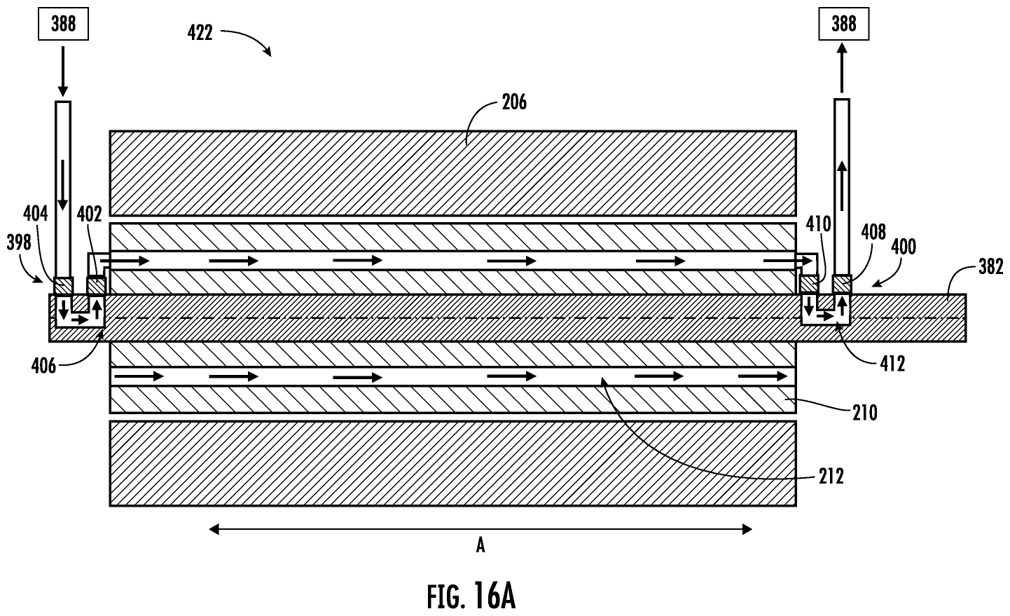

With reference to FIG. 15, a side cross-sectional view of the electric machine 420 is provided. As described above, in the serial flow configuration, the coolant supply 388 provides the coolant directly to cooling apparatuses 214 in the stator assembly 202 without an additional manifold. In the serial flow configuration, the coolant flows through the first one of the cooling apparatuses 214, then sequentially flowing through the cooling apparatuses 214 around the stator assembly 202, until flowing through the last one of the cooling apparatus 214 to return to the coolant supply 388.

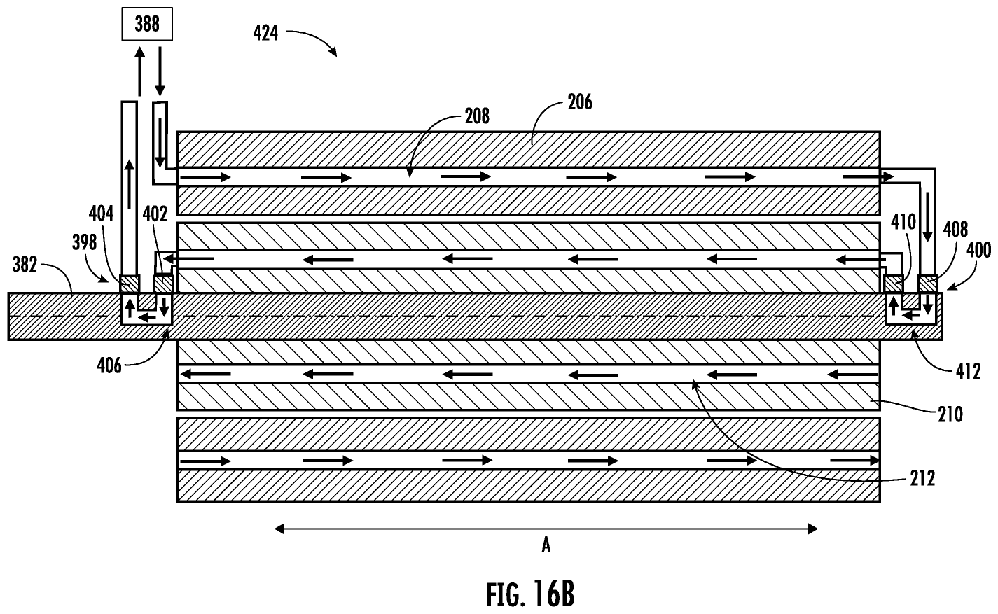

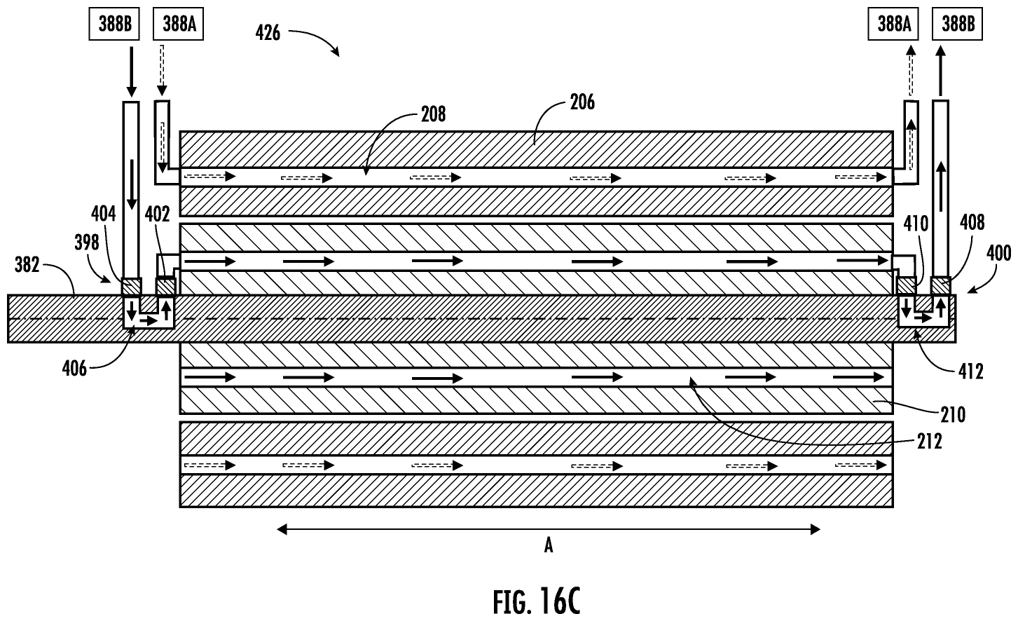

As shown in FIGS. 16A-16C, side cross-sectional views of other exemplary electric machines are provided. FIG. 16A shows an electric machine 422 with a coolant supply 388 providing coolant to cooling apparatuses 214 in a rotor assembly 204. FIG. 16B shows an electric machine 424 with a coolant supply 388 providing coolant to cooling apparatuses 214 in a stator assembly 202 and to cooling apparatuses 214 in a rotor assembly 204. FIG. 16C shows an electric machine 426 with a first coolant supply 388A providing coolant to cooling apparatuses 214 in a stator assembly 202 and a second coolant supply 388B providing coolant to cooling apparatuses 214 in a rotor assembly 204.

As shown in FIG. 16A, the coolant supply 388 provides the coolant to the cooling apparatuses 214 in the rotor assembly 204. As described above with respect to FIG. 13A, the electric machine includes a first rotary fluid coupling 398 disposed in a shaft 382 and a second rotary fluid coupling 400 disposed in the shaft 382. The coolant supply 388 provides the coolant to an inlet 402 of the first rotary fluid coupling 398, which flows through a channel 406 to an outlet 404. The outlet 404 provides the coolant to an inlet manifold 224 (FIG. 14) of a first one of the cooling apparatuses 214 in the rotor assembly 204. The coolant flows sequentially to each of the cooling apparatuses 214 of the rotor assembly 204 and then through the cooling apparatuses 214 through rotor slots 212 of a rotor core 210.

The coolant then flows sequentially through the cooling apparatuses 214 to an outlet manifold 226 (FIG. 14) of a last one of the cooling apparatuses 214 to an inlet 408 of the second rotary fluid coupling 400. A channel 412 allows the coolant to flow from the inlet 408 to an outlet 410, which provides the coolant to the coolant supply 388. As the shaft 382 rotates, the inlet 402 of the first rotary fluid coupling 398 rotates into and out of engagement with the coolant supply 388, thereby allowing the coolant to flow only during a portion of rotation of the shaft 382.

As shown in FIG. 16B, the coolant supply 388 provides the coolant first to the cooling apparatuses 214 in the stator assembly 202 and then to the cooling apparatuses 214 in the rotor assembly 204. As described with respect to FG. 13B, the electric machine includes a first rotary fluid coupling 398 disposed in a shaft 382 and a second rotary fluid coupling 400 disposed in the shaft 382. The coolant supply 388 provides the coolant to one of the cooling apparatuses 214 of the stator assembly 202, which provides the coolant to the others of the cooling apparatuses 214 of the stator assembly 202 in the serial flow configuration.

The coolant then flows from the cooling apparatuses 214 of the stator assembly 202 to an inlet 408 of the second rotary fluid coupling 400, which flows through a channel 412 to an outlet 410. The outlet 410 provides the coolant to one of the cooling apparatuses 214 of the rotor assembly 204, which provides the coolant to the others of the cooling apparatuses 214 of the rotor assembly 204 in the serial flow configuration. The coolant flows through the rotor assembly 204 to an inlet 402 of the first rotary fluid coupling 398, which flows through a channel 406 to an outlet 404. The outlet 404 of the first rotary fluid coupling 398 is fluidly connected to the coolant supply 388. In the configuration of FIG. 16B, the coolant flows through the stator slots 208 along the axial direction A to the second rotary fluid coupling 400, and then against the axial direction A through the rotor slots 212 to the first rotary fluid coupling 398.

As shown in FIG. 16C, the first coolant supply 388A provides the coolant to the cooling apparatuses 214 in the stator assembly 202, and the second coolant supply 388B provides the coolant to the cooling apparatuses 214 in the rotor assembly 204. More specifically, the first coolant supply 388A is connected to an inlet manifold 224 of one of the cooling apparatuses 214 of the stator assembly 202, which provides the coolant to the others of the cooling apparatuses 214 of the stator assembly 202 in the serial flow configuration. The coolant flows through the stator assembly 202 to an outlet manifold 226 of one of the cooling apparatuses 214, which provides the coolant to the first coolant supply 388A.

The second coolant supply 388B is connected to an inlet 402 of a first rotary fluid coupling 398, which provides the coolant through a channel 406 to an outlet 404. The outlet 404 of the first rotary fluid coupling 398 is connected to an inlet manifold 224 of one of the cooling apparatuses 214 of the rotor assembly 204, which provides the coolant to the others of the cooling apparatuses 214 of the rotor assembly 204 in the serial flow configuration. The coolant flows through the rotor assembly 204 to an outlet manifold 226 of one of the cooling apparatuses 214 of the rotor assembly 204, which provides the coolant to an inlet 408 of a second rotary fluid coupling 400. The coolant flows through a channel 412 to an outlet 410, which provides the coolant to the second coolant supply 388B. In the exemplary embodiment of FIG. 16C, the coolant flows through both the stator assembly 202 and through the rotor assembly 204 in an axial direction A, i.e., in the same direction. It will be appreciated that the coolant supplies 388A, 388B may provide the coolant to the electric machine 426 in opposing directions (i.e., a counterflow configuration).

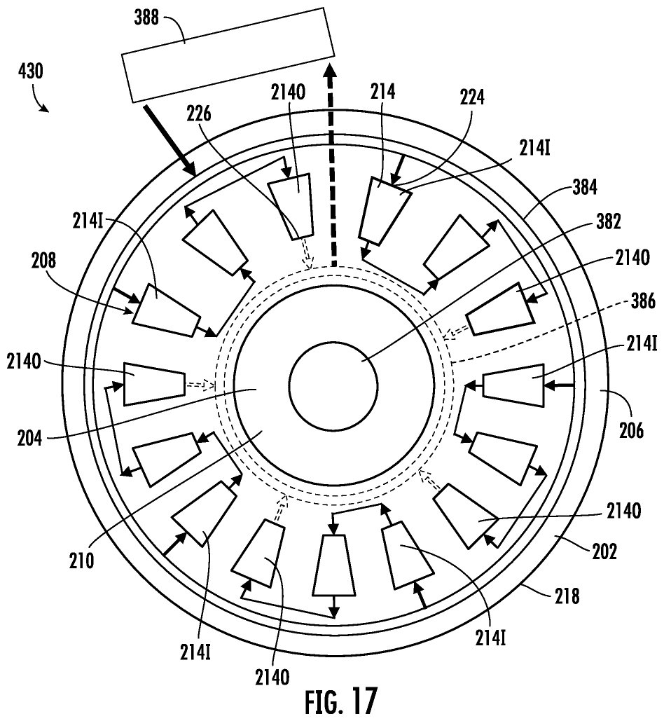

Now referring to FIG. 17, an axial schematic view of an electric machine 430 is provided. A stator assembly 202 of the electric machine 430 includes a stator core 206 and a plurality of cooling apparatuses 214 disposed in stator slots 208 of the stator core 206. A rotor assembly 204 is disposed radially inward of the stator assembly 202, and the rotor assembly 204 does not include any cooling apparatuses 214 in this exemplary embodiment. The rotor assembly 204 includes a rotor core 210 and a shaft 382.

The cooling apparatuses 214 are arranged in a hybrid configuration, which combines features from both the parallel flow configuration of FIG. 11 and the serial flow configuration of FIG. 14. More specifically, the electric machine 430 includes a radial inlet manifold 384 that provides coolant from a coolant supply 388 to certain ones of the cooling apparatuses 214, referred to here as “inlet” cooling apparatuses 214I in FIG. 17. Each inlet cooling apparatus is in the parallel flow configuration with each other inlet cooling apparatus 2141, and each inlet cooling apparatus 214I is in the serial flow configuration with others of the cooling apparatuses 214. That is, each inlet cooling apparatus 214I provides the coolant to the other cooling apparatuses 214 in the serial flow configuration.

As the coolant flows through the stator assembly 202, the coolant flows from certain ones of the cooling apparatuses 214 to a radial outlet manifold 386. The cooling apparatuses 214 that are in fluid communication with the radial outlet manifold 386 are referred to here as “outlet” cooling apparatuses 2140 in FIG. 17. The outlet cooling apparatuses 2140 receive coolant from the other cooling apparatuses 214 in the serial flow configuration and transmit the coolant to the radial outlet manifold 386. The radial outlet manifold 386 then transmits the coolant to the coolant supply 388. The hybrid flow configuration provides improved temperature uniformity and flow variation within the plurality of cooling apparatuses 214.

The coolant supply 388 may be part of a closed-loop cooling system (not shown) arrangement with a pump, an external heat exchanger, and a coolant reservoir. The coolant may be any suitable type, such as liquid helium, liquid nitrogen, water, oil, supercritical carbon dioxide, or combinations thereof. In operation, cold coolant is pumped to the electric machine 200 to cool the windings and core. Hot coolant exiting the electric machine 200 then passes through one or more heat exchangers to transfer thermal energy to a heat-sink fluid. Cold coolant exiting the heat exchangers then returns to the pump in a closed-loop. This closed loop may be connected to a coolant reservoir to enable startup and transient scenarios. The cold heat-sink fluid may be fuel, liquid hydrogen, or air obtained from a source such as a fuel tank or the LP compressor. The hot heat-sink fluid exiting the heat exchangers may be sent to the combustion chamber.

By incorporating cooling apparatuses into the electric machine, liquid coolant is provided to cool the windings disposed in the stator and the rotor without leaking into the stator slots or rotor slots. More specifically, the channels of the cooling apparatuses allow coolant to flow through the stator slots and the rotor slots, thereby absorbing heat from the windings, without flooding the stator or the rotor. Moreover, by forming a fluidtight chamber for the coolant that reduces or inhibits contact between the coolant and the windings, the electric machine may not need the additional components that are used when flooding the stator or the rotor with the coolant. Thus, the cooling apparatuses provide improved efficiency and lifespan of the electric machine.

Further aspects are provided by the subject matter of the following clauses:

A cooling apparatus for an electric machine defining an axial direction, the cooling apparatus including a body extending from a first end to a second end, the body defining an outer surface, an inner surface, and a cavity interior of the inner surface, the cavity configured to receive electric machine windings of the electric machine, a plurality of channels defined in the body, the plurality of channels extending from the first end to the second end, each of the plurality of channels disposed between the inner surface and the outer surface, and a manifold defining a fluid port, wherein the manifold is arranged to engage the body at one of the first end or the second end to form a fluidtight chamber enclosing the plurality of channels from the cavity, wherein the fluidtight chamber is in fluid communication with the fluid port.

The cooling apparatus of the preceding clause, further including a second manifold defining a fluid port, wherein the second manifold is arranged to engage the body at the other of the first end or the second end to form a fluidtight chamber enclosing the plurality of channels from the cavity.

The cooling apparatus of any of the preceding clauses, wherein the body further includes a plurality of dividers extending from the outer surface to the inner surface and extending from the first end to the second end, wherein the plurality of channels are defined between adjacent ones of the plurality of dividers.

The cooling apparatus of any of the preceding clauses, wherein the plurality of dividers each extend along a straight line along the axial direction from the first end to the second end.

The cooling apparatus of any of the preceding clauses, wherein the plurality of dividers each extend along a serpentine line from the first end to the second end.

The cooling apparatus of any of the preceding clauses, wherein the plurality of dividers each extend along a helical line from the first end to the second end.

The cooling apparatus of any of the preceding clauses, wherein the body includes a plurality of unit cells, each unit cell defining a microchannel, wherein the plurality of channels are defined by the respective microchannels of the plurality of unit cells.

The cooling apparatus of any of the preceding clauses, wherein one of more layers of the plurality of unit cells are disposed between the inner surface and the outer surface.

The cooling apparatus of any of the preceding clauses, wherein each unit cell defines a plurality of surfaces, the microchannel of each unit cell extends between at least two of the plurality of surfaces, and the microchannel is in fluid communication with at least one microchannel of at least one adjacent one of the plurality of unit cells.

The cooling apparatus of any of the preceding clauses, wherein at least one of the microchannels is a junction, the junction including a first inlet, a second inlet and an outlet, wherein the junction is arranged to combine a fluid flowing through the first inlet with a fluid flowing through the second inlet to a combined fluid flow through the outlet.

The cooling apparatus of any of the preceding clauses, wherein each unit cell defines a plurality of surfaces and a center, and wherein the junction is defined either on the surface of the unit cell or at the center of the unit cell.

The cooling apparatus of any of the preceding clauses, further including a coolant supply in fluid communication with the fluid port of the manifold.

The cooling apparatus of any of the preceding clauses, wherein the body includes an outer sleeve defining the outer surface and an inner sleeve defining the inner surface and the cavity, and wherein the plurality of channels are defined between the outer sleeve and the inner sleeve.

The cooling apparatus of any of the preceding clauses, wherein the manifold is arranged to engage the body at the same side as a second manifold, and wherein the manifold and the second manifold are adjacent to each other, wherein the cooling apparatus further includes a partition defined between the manifold and the second manifold.

The cooling apparatus of any of the preceding clauses, wherein the inner surface includes a first side and a second side opposing the first side, and wherein the body further includes a platform extending from the first side to the second side, and wherein the plurality of channels include one or more channels defined in the platform.

The cooling apparatus of any of the preceding clauses, wherein the manifold defines an inner portion at one of the first end or the second end of the body and an outer portion at one of the first end or the second end of the body, and wherein the fluid port is defined at either the inner portion or the outer portion.

The cooling apparatus of any of the preceding clauses, wherein the coolant is a fluid in either a liquid, gaseous, supercritical, or cryogenic state.

The cooling apparatus of any of the preceding clauses, wherein the body includes an outer sleeve defining the outer surface and an inner sleeve defining the inner surface and the cavity, and wherein a plurality of cylindrical features or pins extend from the outer sleeve to the inner sleeve.

An electric machine for a gas turbine engine defining an axial direction, the electric machine including a stator assembly including a stator core defining a plurality of stator slots in the axial direction, a rotor assembly including a rotor core defining a plurality of rotor slots in the axial direction, the rotor assembly rotatable within the stator assembly, and a plurality of cooling apparatuses, each of the plurality of cooling apparatuses disposed in one of the plurality of stator slots or disposed in one of the plurality of rotor slots. Each of the plurality of cooling apparatuses includes a body extending from a first end to a second end, the body defining an outer surface, an inner surface, and a cavity interior of the inner surface, a plurality of channels defined in the body, the plurality of channels extending from the first end to the second end, each of the plurality of channels disposed between the inner surface and the outer surface, an inlet manifold attached to the body at the first end, and an outlet manifold attached to the body at the second end, wherein inlet manifold, the outlet manifold, and the body form a fluidtight chamber enclosing the plurality of channels from the cavity.

The electric machine of any of the preceding clauses, wherein the outlet manifold of a first one of the plurality of cooling apparatuses is in fluid communication with the inlet manifold of an adjacent second one of the plurality of cooling apparatuses.

The electric machine of any of the preceding clauses, wherein the outlet manifold of each of the plurality of cooling apparatuses is in fluid communication with the respective inlet manifolds of each adjacent one of the plurality of cooling apparatuses to form a serial flowpath.

The electric machine of any of the preceding clauses, further including a radial inlet manifold fluidly connected to the inlet manifold of at least one of the plurality of cooling apparatuses and a radial outlet manifold fluidly connected to the outlet manifold of at least one of the plurality of cooling apparatuses.

The electric machine of any of the preceding clauses, further including a plurality of windings disposed in each cavity of the plurality of cooling apparatuses.

The electric machine of any of the preceding clauses, wherein at least one of the plurality of cooling apparatuses further includes an inlet clip attached to the inlet manifold and an outlet clip attached to the outlet manifold, wherein the inlet clip engages one of the stator core or the rotor core, and the outlet clip engages one of the stator core or the rotor core.

The electric machine of any of the preceding clauses, further including a rotary fluid coupling arranged to provide a coolant to one of the plurality of cooling apparatuses disposed in one of the plurality of rotor slots.

The electric machine of any of the preceding clauses, wherein the rotary fluid coupling is arranged to rotate into engagement with a coolant supply to receive the coolant and arranged to rotate out of engagement with the coolant supply to cease receiving the coolant.

The electric machine of any of the preceding clauses, wherein the outlet manifold of one of the plurality of cooling apparatuses is fluidly connected to the inlet manifold of an adjacent one of the plurality of cooling apparatus to form a hybrid flowpath.

The electric machine of any of the preceding clauses, wherein the plurality of cooling apparatuses disposed in the plurality of stator slots are in fluid communication with the plurality of cooling apparatuses disposed in the plurality of rotor slots.

The electric machine of any of the preceding clauses, wherein the rotor assembly further includes a shaft, and wherein a channel defined in the shaft is in fluid communication with the rotary fluid coupling.

The electric machine of any of the preceding clauses, further including one or more coolant supplies in fluid communication with the cooling apparatuses.

A gas turbine engine includes a turbomachine including a compressor, a combustor, and a turbine arranged in serial flow order, and an electric machine defining an axial direction, the electric machine including a stator and a rotor rotatable within the stator. The electric machine further includes a plurality of cooling apparatuses, each of the plurality of cooling apparatuses disposed through the stator in the axial direction or disposed through the rotor in the axial direction. Each of the plurality of cooling apparatuses includes a body extending from a first end to a second end in the axial direction, the body defining a cavity and a plurality of a plurality of channels extending from the first end to the second end. and a plurality of windings disposed in the cavity of each of the plurality of cooling apparatuses.

The gas turbine engine of any of the preceding clauses, further including a manifold configured to engage the body to enclose the plurality of channels from the cavity.

The gas turbine engine of any of the preceding clauses, further including a rotary fluid coupling arranged to provide a coolant to one of the plurality of cooling apparatuses disposed in one of a plurality of rotor slots.

The gas turbine engine of any of the preceding clauses, wherein the rotary fluid coupling is arranged to rotate into engagement with a coolant supply to receive the coolant and arranged to rotate out of engagement with the coolant supply to cease receiving the coolant.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooling apparatus for an electric machine defining an axial direction, the cooling apparatus comprising:
a body extending from a first end to a second end, the body defining an outer surface, an inner surface, and a cavity interior of the inner surface, the cavity configured to receive electric machine windings of the electric machine;
a plurality of channels defined in the body, the plurality of channels extending from the first end to the second end, each of the plurality of channels disposed between the inner surface and the outer surface; and
a manifold defining a fluid port, wherein the manifold is arranged to engage the body at one of the first end or the second end,
wherein, when the manifold engages the one of the first end or the second end, the manifold and the inner surface of the body form a fluidtight chamber enclosing the plurality of channels from the cavity,
wherein the fluidtight chamber is in fluid communication with the fluid port.

2. The cooling apparatus of claim 1, further comprising:
a second manifold defining a fluid port, wherein the second manifold is arranged to engage the body at the other of the first end or the second end to form the fluidtight chamber with the manifold and the inner surface of the body.

3. The cooling apparatus of claim 1, wherein the body further includes a plurality of dividers extending from the outer surface to the inner surface and extending from the first end to the second end, wherein the plurality of channels are defined between adjacent ones of the plurality of dividers.

4. The cooling apparatus of claim 3, wherein the plurality of dividers each extend along a straight line along the axial direction from the first end to the second end.

5. The cooling apparatus of claim 3, wherein the plurality of dividers each extend along a serpentine line from the first end to the second end.

6. The cooling apparatus of claim 3, wherein the plurality of dividers each extend along a helical line from the first end to the second end.

7. The cooling apparatus of claim 1, wherein the body includes a plurality of unit cells, each unit cell defining a microchannel, wherein the plurality of channels are defined by the respective microchannels of the plurality of unit cells.

8. The cooling apparatus of claim 7, wherein each unit cell defines a plurality of surfaces, the microchannel of each unit cell extends between at least two of the plurality of surfaces, and the microchannel is in fluid communication with at least one microchannel of at least one adjacent one of the plurality of unit cells.

9. The cooling apparatus of claim 7, wherein at least one of the microchannels is a junction, the junction including a first inlet, a second inlet and an outlet, wherein the junction is arranged to combine a fluid flowing through the first inlet with a fluid flowing through the second inlet to a combined fluid flow through the outlet.

10. The cooling apparatus of claim 1, further comprising a coolant supply in fluid communication with the fluid port of the manifold.

11. The cooling apparatus of claim 1, wherein the body includes an outer sleeve defining the outer surface and an inner sleeve defining the inner surface and the cavity, and wherein the plurality of channels are defined between the outer sleeve and the inner sleeve.

12. The cooling apparatus of claim 1, wherein the inner surface includes a first side and a second side opposing the first side,
wherein the body further comprises a platform extending from the first side to the second side, and
wherein the plurality of channels include one or more channels defined in the platform.

13. An electric machine for a gas turbine engine defining an axial direction, the electric machine comprising:
a stator assembly comprising a stator core defining a plurality of stator slots in the axial direction;
a rotor assembly comprising a rotor core defining a plurality of rotor slots in the axial direction, the rotor assembly rotatable within the stator assembly; and
a plurality of cooling apparatuses, each one of the plurality of cooling apparatuses disposed in one of the plurality of stator slots or disposed in one of the plurality of rotor slots, each of the plurality of cooling apparatuses comprising:
a body extending from a first end to a second end, the body defining an outer surface, an inner surface, and a cavity interior of the inner surface;
a plurality of channels defined in the body, the plurality of channels extending from the first end to the second end, each of the plurality of channels disposed between the inner surface and the outer surface;
an inlet manifold attached to the body at the first end, and
an outlet manifold attached to the body at the second end,
wherein the inlet manifold, the outlet manifold, the body, and the inner surface of the body form a fluidtight chamber enclosing the plurality of channels from the cavity.

14. The electric machine of claim 13, wherein the outlet manifold of a first one of the plurality of cooling apparatuses is in fluid communication with the inlet manifold of an adjacent second one of the plurality of cooling apparatuses.

15. The electric machine of claim 14, wherein the outlet manifold of each of the plurality of cooling apparatuses is in fluid communication with the respective inlet manifolds of each adjacent one of the plurality of cooling apparatuses to form a serial flowpath.

16. The electric machine of claim 13, further comprising a radial inlet manifold fluidly connected to the inlet manifold of at least one of the plurality of cooling apparatuses and a radial outlet manifold fluidly connected to the outlet manifold of at least one of the plurality of cooling apparatuses.

17. The electric machine of claim 13, further comprising a plurality of windings disposed in each cavity of the plurality of cooling apparatuses.

18. The electric machine of claim 13, wherein at least one of the plurality of cooling apparatuses further comprises an inlet clip attached to the inlet manifold and an outlet clip attached to the outlet manifold, wherein the inlet clip engages one of the stator core or the rotor core, and the outlet clip engages one of the stator core or the rotor core.

19. The electric machine of claim 13, further comprising a rotary fluid coupling arranged to provide a coolant to one of the plurality of cooling apparatuses disposed in one of the plurality of rotor slots.

20. The electric machine of claim 19, wherein the rotary fluid coupling is arranged to rotate into engagement with a coolant supply to receive the coolant and arranged to rotate out of engagement with the coolant supply to cease receiving the coolant.
